(19) United States
(12) Patent Application Publication
(10) Pub. No.: US 2025/0156146 A1
(43) Pub. Date: May 15, 2025

(54) HARDWARE ACCELERATION CIRCUIT, CHIP, DATA PROCESSING ACCELERATION METHOD, ACCELERATOR, AND DEVICE

(71) Applicant: Guangzhou Xiaopeng Autopilot Technology Co., Ltd., Guangzhou (CN)

(72) Inventors: Subhash Balam, Guangzhou (CN); Hengchang Xiong, Guangzhou (CN); Yuanxiang Guo, Guangzhou (CN); Yu Hu, Guangzhou (CN); Weijun Zhang, Guangzhou (CN); Jiang Jiang, Guangzhou (CN); Chia-Lin Lu, Guangzhou (CN)

(21) Appl. No.: 18/389,423

(22) Filed: Nov. 14, 2023

(51) Int. Cl. G06F 7/498

(52) U.S. Cl. CPC G06F 7/4988

(57) ABSTRACT

A hardware acceleration circuit, a chip, a data processing acceleration method, an accelerator, and a device are provided. The circuit includes: a lookup table circuit, configured to: in response to an i^{th} element in an input data set, output an exponential function value corresponding to a first index value of the i^{th} element based on a first lookup table, and/or output a reciprocal of the exponential function value corresponding to a second index value of the i^{th} element based on a second lookup table; an adder, configured to output an addition operation result of exponential function values corresponding to at least some elements in the input data set; and a multiplier, configured to output a multiplication operation result of a reciprocal of an exponential function value corresponding to the i^{th} element and the addition operation result, to obtain a reciprocal of a specific function value corresponding to the i^{th} element.

### FIELD OF THE INVENTION

This application relates to the field of artificial intelligence technologies, and in particular, to a hardware acceleration circuit, an artificial intelligence chip, a data processing acceleration method, an artificial intelligence accelerator, and an electronic device.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

A non-linear function introduces non-linear characteristics into an artificial neural network, which plays a very important role in learning and understanding a complex scenario by the artificial neural network. The non-linear function includes but is not limited to a Softmax (Softmax) function, a Sigmoid function, and the like.

For example, the Softmax function is widely applied to deep learning. In the related art, a function value of the Softmax function may be calculated by using a general-purpose calculation unit, for example, a central processing unit (CPU) or a graphics processing unit (GPU). However, in a case that a processing process of a neural network is executed by, for example, a hardware circuit such as a deep learning accelerator (deep learning accelerator, DLA for short), a neural network processing unit (neural network processing unit, NPU for short), or the like, if a Softmax function layer is located at a network intermediate layer of the neural network, overheads of job migration (job migration) between the DLA/NPU and the CPU/GPU may be caused, causing low efficiency of a solution in which a non-linear function value is determined by using the CPU/GPU, and resulting in increased system bandwidth and higher power consumption.

Therefore, a heretofore unaddressed need exists in the art to address the aforementioned deficiencies and inadequacies.

### SUMMARY OF THE INVENTION

To resolve or partially resolve problems in the related art, this application provides a hardware acceleration circuit, an artificial intelligence chip, a data processing acceleration method, an artificial intelligence accelerator, and an electronic device, which can improve a data processing speed during calculation of a non-linear function, to speed up obtaining a function value.

A first aspect of this application provides a hardware acceleration circuit, including: a lookup table circuit, configured to: in response to an i^{th} element in an input data set, output an exponential function value corresponding to a first index value of the i^{th} element based on a first lookup table, and/or output a reciprocal of the exponential function value corresponding to a second index value of the i^{th} element based on a second lookup table, wherein i is an integer greater than or equal to 1; an adder, configured to output an addition operation result of exponential function values corresponding to at least some elements in the input data set; and a multiplier, configured to output a multiplication operation result of the reciprocal of the exponential function value corresponding to the i^{th} element and the addition operation result, to obtain a reciprocal of a specific function value corresponding to the i^{th} element, and obtain the specific function value corresponding to the i^{th} element.

A second aspect of this application provides an artificial intelligence chip, including the hardware acceleration circuit.

A third aspect of this application provides a data processing acceleration method, including: obtaining an exponential function value corresponding to an i^{th} element in an input data set, and obtaining a reciprocal of the exponential function value corresponding to the i^{th} element, wherein i is an integer greater than or equal to 1; obtaining an addition operation result of exponential function values corresponding to at least some elements in the input data set; and obtaining a specific function value corresponding to the i^{th} element based on the reciprocal of the exponential function value corresponding to the i^{th} element and the addition operation result.

A fourth aspect of this application provides an artificial intelligence accelerator, including: a processor; and a memory, storing executable code, where the executable code, when executed by the processor, causes the processor to perform the method described above.

A fifth aspect of this application provides an electronic device, including: a processor, configured to send at least one of a first lookup table, a second lookup table, or a third lookup table to an artificial intelligence chip, where the first lookup table includes a first mapping relationship between an i^{th} element in an input data set and an exponential function value, the second lookup table includes a second mapping relationship between the i^{th} element in the input data set and a reciprocal of the exponential function value, the third lookup table includes a third mapping relationship between a multiplication operation result of the reciprocal of the exponential function value corresponding to the i^{th} element and an addition operation result and a reciprocal of the multiplication operation result, the addition operation result being an addition operation result of exponential function values corresponding to at least some elements in the input data set; and an artificial intelligence chip, configured to perform the foregoing method based on at least one of the first lookup table, the second lookup table, or the third lookup table.

A sixth aspect of this application provides a computer-readable storage medium, storing executable code, where the executable code, when executed by a processor of an electronic device, causes the processor to perform the foregoing method.

A seventh aspect of this application provides a computer program product, including executable code, where the executable code, when executed, implements the foregoing method.

The technical solutions provided in this application may have the following advantageous effects:

In the embodiment of this application, an inverse operation is performed on a specific function, so that an addition operation result of exponential function values corresponding to at least some elements in the input data set (which is referred to as an accumulated value of exponential function values for short) becomes a numerator, and a reciprocal of an exponential function value corresponding to an i^{th} element (which is referred to as a reciprocal of an exponential function value for short) becomes a denominator. When a reciprocal of an exponent and an accumulated value of exponents are too large, a reciprocal of a multiplication operation result of the reciprocal and the accumulated value approximates 0. Because a specific function value close to 1 may be more concerned in a neural network, data approximates 0 may be saturated and ignored. Based on the inverse operation performed on the specific function, when at least one of the exponential function value, the reciprocal of the exponential function value, or the specific function value is obtained by using a lookup table, a lookup table with fewer entries is used. This is more acceptable for hardware implementation. Moreover, precision of the specific function value obtained through calculation may further be improved based on reducing the entries of the lookup table.

In addition, in some embodiments of this application, an intermediate result generated in a process of determining the specific function and a data format used by the specific function value are set, so that precision of the obtained specific function value may be further improved.

In addition, in some embodiments of this application, the intermediate result is stored by using storage space having a specified quantity of bits, and data is captured from the intermediate result in combination with a shift operation, so that a function of saturating and ignoring saturation data is conveniently implemented.

It is to be understood that the above general descriptions and the following detailed descriptions are merely for exemplary and explanatory purposes, and are not intended to limit this application.

### BRIEF DESCRIPTION OF THE DRAWINGS

Through a more detailed description of exemplary implementations of this application in combination with the accompanying drawings, the above and other objectives, features and advantages of this application are more obvious. In the exemplary implementations of this application, same reference numerals generally represent same components.

FIG. 1 is a schematic structural diagram of a neural network according to an embodiment of this application;

FIG. 2 is a schematic structural diagram of a neural network for classification according to an embodiment of this application;

FIG. 3 is a block diagram of a hardware acceleration circuit according to an embodiment of this application;

FIG. 4 to FIG. 7 are block diagrams of hardware acceleration circuits according to some other embodiments of this application;

FIG. 8 is a schematic flowchart of a data processing acceleration method according to an embodiment of this application;

FIG. 9 is a schematic diagram of an inverse operation according to an embodiment of this application;

FIG. 10 is a logic diagram of a data processing acceleration method according to an embodiment of this application;

FIG. 11 is a schematic diagram of formats of data in a process of performing a data processing acceleration method according to an embodiment of this application;

FIG. 12 is a schematic structural diagram of a data processing acceleration apparatus according to an embodiment of this application;

FIG. 13 is a schematic structural diagram of an artificial intelligence accelerator according to an embodiment of this application; and

FIG. 14 is a schematic structural diagram of an electronic device according to an embodiment of this application.

### DETAILED DESCRIPTION OF THE INVENTION

The following describes in detail implementations of this application with reference to the accompanying drawings. Although the accompanying drawings show the implementations of this application, it should be understood that this application may be implemented in various manners and is not limited by the implementations described herein. On the contrary, the implementations are provided to make this application more thorough and complete, and the scope of this application can be fully conveyed to a person skilled in the art.

The terms used in this application are for the purpose of describing specific embodiments only and are not intended to limit this application. The terms “a” and “the” of singular forms used in this application and the appended claims are also intended to include plural forms, unless otherwise specified in the context clearly. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Therefore, a feature limited by “first” or “second” may explicitly or implicitly include one or more features. In the descriptions of this application, “a plurality of” means two or more, unless otherwise definitely and specifically limited.

A calculation procedure of a non-linear function possibly relates to an operation procedure of an exponential function and/or a reciprocal. For example, an operation procedure of a Softmax function may relate to operation procedures of an exponential (exp) and a reciprocal of a sum of exponentials (1/sum_of_exp). A dedicated hardware pipeline used for the Softmax function is not feasible for implementing large-scale computing power. For example, an increase in computing power results in high hardware costs. In the related technology, a manner of obtaining a Softmax function is implemented by looking up a 16-bit integer (INT16) lookup table (LUT). However, the 16-bit LUT is a table occupying a very large storage space and includes, for example, (2\hat{ }16, namely, 65536) entries, and a very large static random access memory (SRAM)/dynamic random access memory (DRAM) is required to store data, which results in excessively high costs of a LUT combinatorial logic circuit. In another aspect, 65536 cycles are required for completing a single LUT result, and processing duration is excessively long.

Embodiments of this application provide a hardware acceleration circuit, a chip, a data processing acceleration method, an accelerator, and an electronic device. An inverse operation is performed on a non-linear function to obtain a plurality of logic components. For example, a Softmax function is decomposed into a sum of exponential functions and a reciprocal of an exponent. At least some logic components in a function may be implemented by using a lookup table occupying a small storage space, and power consumption, bandwidth, performance, and precision of a function value of the non-linear function can be balanced and determined, to satisfy requirements of a neural network.

The following describes in detail the technical solutions in the embodiments of this application with reference to the accompanying drawings.

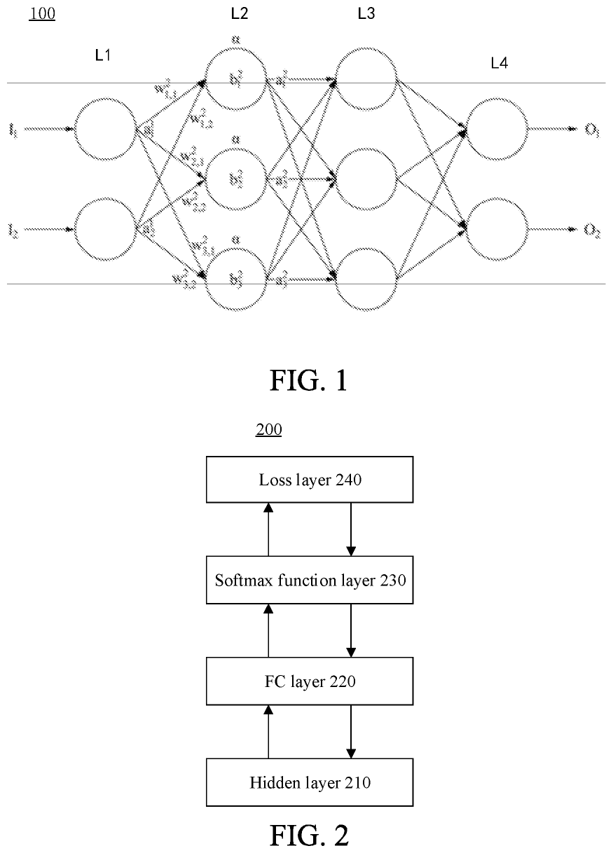

FIG. 1 is a schematic structural diagram of a neural network according to an embodiment of this application.

FIG. 1 shows a topology structure of a neural network 100, including an input layer, a hidden layer, and an output layer. The neural network 100 can execute a calculation or an operation based on input data I₁ and I₂ received by the input layer, and generate output data O₁ and O₂ based on a result of executing the calculation.

For example, the neural network 100 may be a deep neural network (deep neural network, DNN for short) including one or more hidden layers. The neural network 100 in FIG. 1 includes an input layer L1, two hidden layers L2 and L3, and an output layer L4. The DNN includes but is not limited to a convolutional neural network (convolutional neural network, CNN for short), a recurrent neural network (recurrent neural network, RNN for short), and a transformer network (transformer network).

It should be noted that the four layers shown in FIG. 1 are only intended for ease of understanding technical solutions of this application, but cannot be understood as a limitation on this application. For example, the neural network may include more or fewer hidden layers.

Nodes in different layers of the neural network 100 may be connected to each other, to perform data transmission. For example, a node may receive data from another node to execute a calculation on the received data, and output a calculation result to a node in the another layer.

Each node may determine output data of the node based on output data received from a node in a previous layer and a weight. For example, in FIG. 1, W_{1,1}² represents a weight between a first node in a first layer and a first node in a second layer. α₁¹ represents output data of the first node in the first layer. b₁² represents an offset value of the first node in the second layer, and then output data of the first node in the second layer may be represented as: α₁²=((W_{1,1}²×α₁¹)+b₁²). Manners of calculating output data of other nodes are similar, and details are not described herein again.

In some embodiments, an activation function layer such as a Softmax function layer is configured in the neural network, and the Softmax function layer may convert a result value about each class to a probability value.

In some embodiments, a loss function layer is configured in the neural network after the Softmax function layer, and the loss function layer can calculate a loss as a target function for training or learning.

It may be understood that, the neural network may process, in response to to-be-processed data, the to-be-processed data, to obtain a recognition result. The to-be-processed data may include but is not limited to at least one of voice data, text data, and image data.

A typical type of neural network is a neural network for classification. The neural network for classification may determine a class of input data by calculating the input data and a probability corresponding to each class.

FIG. 2 is a schematic structural diagram of a neural network for classification according to an embodiment of this application.

Referring to FIG. 2, a neural network 200 for classification of this embodiment may include a hidden layer 210, a fully-connected layer (fully-connected Layer, FC layer for short) 220, a Softmax function layer 230, and a loss function layer 240.

The neural network 200 performs, in response to to-be-classified data, a calculation sequentially in an order of the hidden layer 210 and the FC layer 220, the FC layer 220 outputs a calculation result s, and the result s corresponds to a classification probability of the to-be-classified data. The FC layer 220 may include a plurality of nodes corresponding to a plurality of classes respectively, and each node outputs a result value corresponding to a probability that the to-be-classified data is classified as a corresponding class. For example, referring to FIG. 1 together, the FC layer corresponds to the output layer L4 in FIG. 1, and has two nodes corresponding to two classes (a first class and a second class), where an output value of one node may be a result value representing a probability that the to-be-classified data is classified as the first class, and an output value of the other node may be a result value representing a probability that the to-be-classified data is classified as the second class. Functions of the hidden layer 210, the FC layer 220, the Softmax function layer 230, and the loss function layer 240 may be implemented by an artificial intelligence chip. The artificial intelligence chip includes but is not limited to a DLA, an NPU, and the like.

The FC layer 220 outputs the calculation result s to the Softmax function layer 230, and the Softmax function layer 230 converts the calculation result s into a probability value y, and may further perform normalization processing on the probability value y. Specifically, the function of the FC layer may be implemented by using a fully-connected layer circuit. For example, the fully-connected layer circuit is configured to transmit, to the hardware acceleration circuit, an i^{th} element or an index value of the i^{th} element in an input data set.

The Softmax function layer 230 outputs the probability value y to the loss function layer 240, and the loss function layer 240 may calculate a cross-entropy loss (cross-entropy loss) L of the result s based on the probability value y. Specifically, the function of the loss function layer 240 may be implemented by using a loss function layer circuit. For example, the loss function layer circuit is configured to transmit, in response to a specific function value from the hardware acceleration circuit, a loss value for the specific function value to the hardware acceleration circuit, so that the hardware acceleration circuit may output a loss gradient value σL/σs for the i^{th} element in the input data set.

In a back-propagation learning procedure, the Softmax function layer 230 calculates a gradient

$$\frac{\partial L}{\partial s}$$

of the cross-entropy loss L. Then, the FC layer 220 executes learning processing based on the gradient

$$\frac{\partial L}{\partial s}$$

of the cross-entropy loss L. For example, a weight of the FC layer 220 may be updated according to a gradient descent algorithm. Further, subsequent learning processing is executed in the hidden layer 210.

It is to be noted that, in FIG. 2, at least some of the hidden layer 210, the FC layer 220, the Softmax function layer 230, and the loss function layer 24 may be implemented using software, or implemented using a hardware circuit, or implemented using a combination of software and hardware. For example, an output s of the FC layer 220 in FIG. 2 may be transmitted to the CPU or GPU. The CPU or GPU calculates the Softmax value y and transmits it back to the loss layer. An output L of the loss layer needs to be transmitted to the CPU or GPU for processing to obtain the gradient o the cross entropy loss L, and then is transmitted to the FC layer 220. In another example, in a case of being implemented using a hardware circuit, the hidden layer 210, the FC layer 220, the Softmax function layer 230, and the loss function layer 240 are each implemented by a hardware circuit, and may be implemented by being integrated into an artificial intelligence chip or distributed in a plurality of chips. Through such a configuration, data migration between another layer of the neural network and a processor such as a CPU/GPU when the Softmax function layer 230 is implemented by the CPU/GPU is avoided, which can increase data processing efficiency of the neural network, reduce data processing delay and power consumption, and avoid an increase in occupied bandwidth.

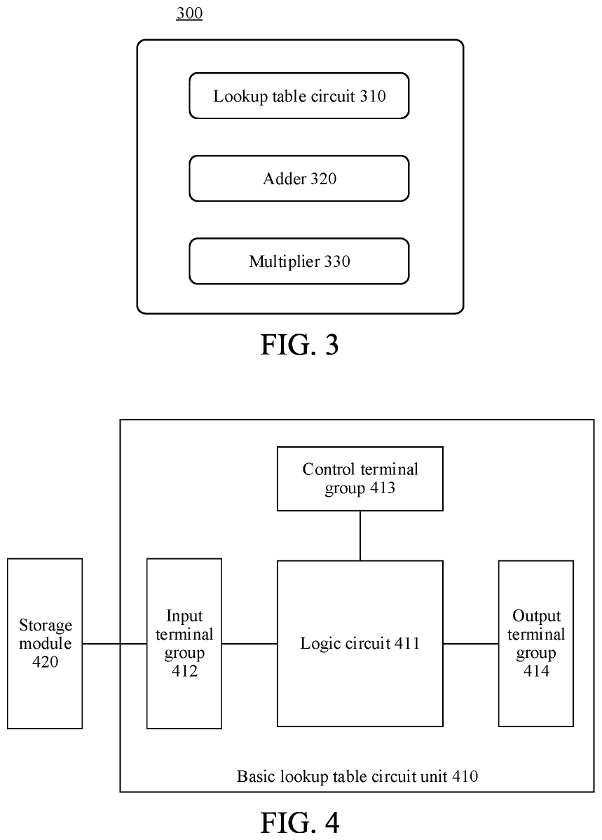

FIG. 3 is a block diagram of a hardware acceleration circuit according to an embodiment of this application. In this application, the hardware acceleration circuit may be, for example, configured to, but not limited to, implement the Softmax function layer 230 in the foregoing neural network 200, and the hardware acceleration circuit may be, for example, but not limited to, a circuit component in a CPLD (complex programmable logic device) chip, an FPGA (field programmable gate array) chip, a dedicated chip, or the like.

Referring to FIG. 3, a hardware acceleration circuit 300 used in artificial intelligence may include a lookup table circuit 310, an adder 320, and a multiplier 330.

The lookup table circuit 310 is configured to: in response to an i^{th} element in an input data set, output an exponential function value corresponding to a first index value of the i^{th} element based on a first lookup table, and/or output a reciprocal of the exponential function value corresponding to a second index value of the i^{th} element based on a second lookup table, wherein i is an integer greater than or equal to 1. The first index value and the second index value may be the same or different The index value may be data of the i^{th} element, or may be obtained through conversion from the i^{th} element, for example, may be some data captured from the data of the i^{th} element.

For example, the first lookup table may be used to implement a first mapping relationship between the first index value of the i^{th} element and the exponential function value for the i^{th} element. The second lookup table may be used to implement a second mapping relationship between the second index value of the i^{th} element and the reciprocal of the exponential function value for the i^{th} element. The first mapping relationship and the second mapping relationship may be preset, for example, a calibrated relationship. By using the first lookup table and the second lookup table, the exponential function value for the i^{th} element and the reciprocal of the exponential function value may be determined through a preset mapping relationship without complex function calculation.

It is to be noted that, at least one of the first mapping relationship and the second mapping relationship may be implemented in the lookup table circuit 310. For example, the exponential function value may be determined by using the first lookup table, or may be calculated by a processor (such as a CPU or GPU) by using software. For example, the reciprocal of the exponential function value may be determined by using the second lookup table, or may be calculated by the processor by using software.

The adder 320 is configured to output an addition operation result of exponential function values corresponding to at least some elements in the input data set. A calculation result of the adder 320 may be data of a specific bit width, for example, data whose bit width is 32 bits (bits), 8-bit data, or the like.

The multiplier 330 is configured to output a multiplication operation result of the reciprocal of the exponential function value corresponding to the i^{th} element and the addition operation result, to obtain a reciprocal of a specific function value corresponding to the i^{th} element, and obtain the specific function value corresponding to the i^{th} element.

It may be understood that, an addition operation result of exponential function values may be a result obtained by performing an addition operation directly on the exponential function values, or may be a result obtained by performing an addition operation on the exponential function values on which specific transformation is performed. For a situation of performing specific transformation, corresponding inverse transformation may be performed on a subsequently obtained data processing result based on a transformation type, or inverse transformation processing is not additionally performed. Similarly, various types of processing performed on other data should also be understood as including the foregoing two situations in a broad sense, but should not be limited to only processing performed on the data itself. Other embodiments are similar, and details are not described again below.

For example, the reciprocal of the exponential function value corresponding to the i^{th} element may be the reciprocal itself based on the exponential function value corresponding to the i^{th} element, or may be data determined after a specific transformation of the reciprocal. For example, the reciprocal may be data with a longer bit width obtained according to preset precision. However, to reduce storage space occupied by the multiplier to reduce hardware costs and improve a response speed, data of a specific bit width is captured from the reciprocal of the specific function value corresponding to the i^{th} element, and the data of a specific bit width is used as the reciprocal of the exponential function value for a subsequent multiplication operation.

Exemplary descriptions are made by using an example in which the specific function is a Softmax function. Assuming that there is an array X, a formula of calculating a Softmax function value of an i^{th} element xᵢ may be shown as formula (1).

$${σ ( x )}_{i} = {e}^{{x}_{i}} \times \frac{1}{{\sum }_{k} {e}^{{x}_{k}}} = {e}^{( xi - {x}_{max} )} \times \frac{1}{{\sum }_{k} {e}^{( {x}_{k} - {x}_{max} )}} \qquad formula ( 1 )$$

In formula (1), σ(x)ᵢ represents a Softmax function value of an i^{th} element xᵢ, e is a natural constant, xᵢ represents an i^{th} element of the array X, xₘₐₓ represents a maximum element in the array X, and

$${\sum }_{k} {e}^{{x}_{k}}$$

represents an addition operation result of exponential function values of at least some elements in the array X.

The denominator in formula (1) has a very wide range, and it is difficult to quantify it into a value range of appropriate integer bit-width data, resulting in problems with too many entries in the lookup table or insufficient precision. For example, when the bit width is large, there are many entries in the lookup table, and the hardware cost is too high. When the bit width is not enough, precision of the specific function value mat v degraded.

In some embodiments, an inverse operation may be performed on the calculation formula of the Softmax function value, as shown in formula (2).

$$\frac{1}{{σ ( x )}_{i}} = {\sum }_{k} {e}^{{x}_{k}} \times \frac{1}{{e}^{{x}_{i}}} = {\sum }_{k} {e}^{( {x}_{k} - {x}_{max} )} \times \frac{1}{{e}^{( {x}_{i} - {x}_{max} )}} \qquad formula ( 2 )$$

In formula (1), a larger e^{(x}^{ᵢ}^{-x}^{ₘₐₓ}⁾ indicates a larger value range and a smaller

$$\frac{1}{{\sum }_{k} {e}^{( {x}_{k} - {x}_{max} )}} \cdot {e}^{( {x}_{i} - {x}_{max} )}$$

is relative to

$${\sum }_{k} {e}^{( {x}_{k} - {x}_{max} )} ,$$

which effectively reduces a value of the integer, and reduces the value range.

$$\frac{1}{{e}^{( {x}_{i} - {x}_{max} )}}$$

is relative to

$$\frac{1}{{\sum }_{k} {e}^{( {x}_{k} - {x}_{max} )}} ,$$

which effectively increases a value of the decimal. When formula (2) is used to determine the Softmax function value, a gap between values of the two parts can be reduced, to facilitate quantification into an appropriate integer bit width, and help improve calculation precision.

In addition, since the Softmax function is inverted, the addition operation result is used as a denominator, and the reciprocal of the specific function value decreases as the addition operation result increases. In some application scenarios, more attention is paid to the scenario where the reciprocal of the specific function value approaches 1. When the addition operation result is relatively large, the reciprocal of the specific function value approaches 0. Therefore, when the addition operation result is relatively large, saturation may be caused due to excessive size and may be ignored. Higher precision requirements can be met with a smaller quantity of entries. For example, the addition operation result may be data of specific bit captured from the 32-bit data, such as 8-bit data captured from the highest bit downwards.

In this embodiment, an inverse operation is performed on a specific function, which effectively reduces the entries of the LUT for determining the reciprocal of the exponential function sum in the related art. This is more acceptable for hardware implementation. In addition, compared with an integer LUT scheme in the related art (using formula (1)), the specific function value determined in this embodiment has higher precision.

In some embodiments, the lookup table circuit is further configured to output, in response to the multiplication operation result, a specific function value corresponding to an index value of the multiplication operation result based on a third lookup table. Since the inverse operation is performed on the specific function, there is an inverse relationship between the multiplication operation result and the specific function value. In the related art, the performance of hardware acceleration circuits in performing division operations is low. In order to quickly obtain a specific function value (that is, obtain the reciprocal of the multiplication operation result), it is inconvenient to use the computing power of the processor to perform inverse operations. In this embodiment, the above problem can be solved by using a LUT. For example, the third lookup table may be used to implement a third mapping relationship between the multiplication operation result and the reciprocal of the multiplication operation result. Certainly, it may be understood that this application does not exclude a manner of implementing the inverse operation through software modules.

In some embodiments, the lookup table circuit 320 includes at least one basic lookup table circuit unit 410.

Referring to FIG. 4, in some embodiments, a basic lookup table circuit unit 410 includes a logic circuit 411, an input terminal group 412, a control terminal group 413, and an output terminal group 414. The input terminal group 412 is connected to a memory 420 and inputs data of a lookup table to the logic circuit 411. The logic circuit 411 selects, through an index value (also referred to as an address) input from the control terminal group 413, a value corresponding to the index value from the lookup table, and outputs the value from the output terminal group 414. The logic circuit 411 may be, for example, a logic gate circuit or a logic switch circuit. It may be understood that, in this application, a terminal group refers to a group of connection ends, including one or more connection ends. In a case that the control terminal group 413 has A control ends and the output terminal group 414 has B output ends, the basic lookup table circuit unit 410 is referred to as A-input and B-output.

The basic lookup table circuit unit 410 may perform table lookup and output based on the stored lookup table. Taking a first lookup table as an example, the lookup table is also A-input and B-output, input data of the lookup table is an index value whose bit width is A bits, and output data is an exponential function value whose bit width is B bits. The first lookup table in the storage area stores a true value of the exponential function value, and the basic lookup table circuit unit is configured to implement a mapping relationship between the index value and the true value of the exponential function value.

In some embodiments, the hardware acceleration circuit may include at least one of the following storage areas:
a first static storage area, configured to store the first lookup table, where the first lookup table is written by a compiler into the first static storage area;
a second static storage area, configured to store the second lookup table, where the second lookup table is written by the compiler into the second static storage area; and
a third static storage area, configured to store the third lookup table, where the third lookup table is written by the compiler into the third static storage area.

The first static storage area, the second static storage area, and the third static storage area are used as a part of the hardware acceleration circuit, for example, may be disposed in static memories such as the ROM, the SRAM, and the like. A size of the static storage area may be determined according to a value domain distribution range of to-be-stored data. For example, the first static storage area, the second static storage area, and the third static storage area may each store an 8-bit (2\hat{ }8) LUT. Taking an 8-bit to 8-bit LUT as an example, the total quantity of entries in the three static storage areas is 3×28=768. If a 16-bit LUT is used, the total quantity of entries is 216-65536. Compared with using one 16-bit LUT, using three 8-bit LUTs effectively reduces the LUT's dependence on large storage space and reduces the area and costs of the lookup table circuit.

It may be understood that, in some embodiments, the lookup tables stored in the first static storage area, the second static storage area, and the third static storage area may be written by another control circuit or processor (such as a CPU or GPU) into the static storage area. Alternatively, each lookup table may also be written into a dynamic memory, such as a DRAM.

In some embodiments, the lookup table circuit may include: a first storage area and a first basic lookup table circuit unit.

The first storage area is configured to store the first lookup table.

The first basic lookup table circuit unit includes a first logic circuit, a first input terminal group, a first control terminal group, and a first output terminal group, where the first input terminal group is connected to the first storage area. The first logic circuit is configured to: output, based on the first lookup table, the exponential function value corresponding to the i^{th} element from the first output terminal group in response to the first index value that is of the i^{th} element in the input data set and that is inputted from the first control terminal group.

In some embodiments, the lookup table circuit may include: a second storage area and a second basic lookup table circuit unit.

The second storage area is configured to store the second lookup table.

The second basic lookup table circuit unit comprises a second logic circuit, a second input terminal group, a second control terminal group, and a second output terminal group, and the second input terminal group is connected to the second storage area. The second logic circuit is configured to output, based on the second lookup table, the reciprocal of the exponential function value of the i^{th} element from the second output terminal group in response to the second index value that is of the i^{th} element in the input data set and that is inputted from the second control terminal group.

In some embodiments, the lookup table circuit may include: a third storage area and a third basic lookup table circuit unit.

The third storage area is configured to store the third lookup table.

The third basic lookup table circuit unit comprises a third logic circuit, a third input terminal group, a third control terminal group, and a third output terminal group, and the third input terminal group is connected to the third storage area. The third logic circuit unit is configured to output, based on the third lookup table, the specific function value corresponding to the index value of the multiplication operation result from the third output terminal group in response to the index value that is of the multiplication operation result and that is inputted from the third control terminal group.

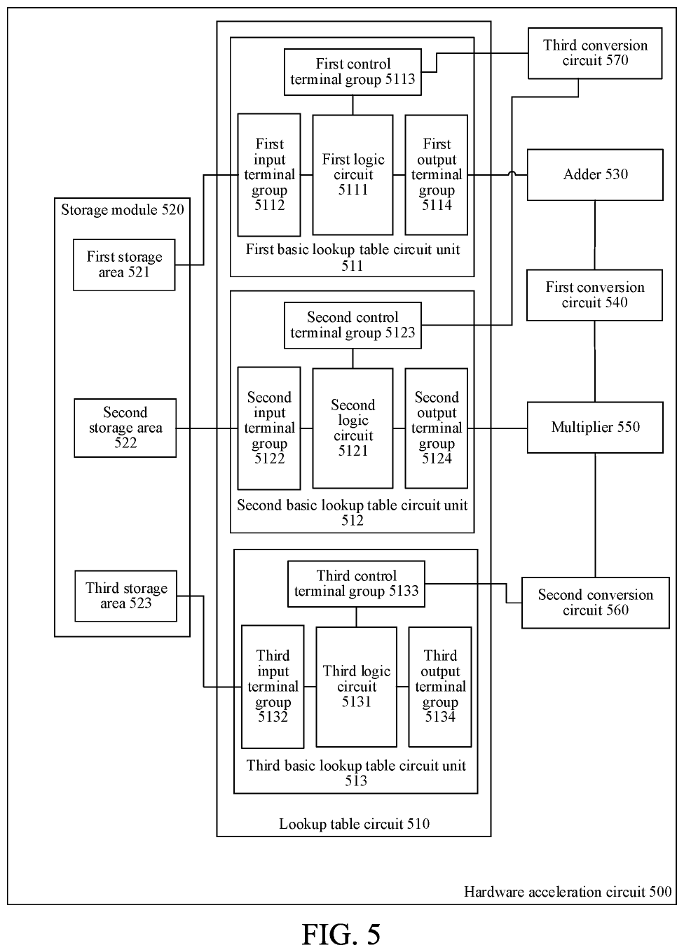

In a specific example, referring to FIG. 5, a hardware acceleration circuit includes: a lookup table circuit 510, a storage module 520, an adder 530, a first conversion circuit 540, a multiplier 550, and a second conversion circuit 560. The storage module 520 includes a first storage area 521 to a third storage area 523. The lookup table circuit 510 includes a first basic lookup table circuit unit 511 to a third basic lookup table circuit unit 513.

The first lookup table is stored in the first storage area 521, the second lookup table is stored in the second storage area 522, and the third lookup table is stored in the third storage area 523.

The first basic lookup table circuit unit 511 includes a first logic circuit 5111, a first input terminal group 5112, a first control terminal group 5113, and a first output terminal group 5114. The first input terminal group 5112 is connected to the first storage area 521. The first logic circuit 5111 is configured to: in response to the index value of the input data inputted from the first control terminal group 5113, output the corresponding exponential function value stored in the first storage area 521 from the first output terminal group 5114.

The second basic lookup table circuit unit 512 includes a second logic circuit 5121, a second input terminal group 5122, a second control terminal group 5123, and a second output terminal group 5124. The second input terminal group 5122 is connected to the second storage area 522. The second logic circuit 5121 is configured to: in response to the index value of the addition operation result inputted from the second control terminal group 5123, output the corresponding reciprocal stored in the second storage area 522 from the second output terminal group 5124.

The third basic lookup table circuit unit 513 includes a third logic circuit 5131, a third input terminal group 5132, a third control terminal group 5133, and a third output terminal group 5134. The third input terminal group 5132 is connected to the third storage area 523. The third logic circuit 5131 is configured to: in response to the index value of the multiplication operation result inputted from the third control terminal group 5123, output the corresponding reciprocal stored in the third storage area 523 from the third output terminal group 5134.

For example, the first basic lookup table circuit unit 511 is N1-input and N2-output The second basic lookup table circuit unit 512 is N1-input and N4-output. The third basic lookup table circuit unit 513 is N5-input and N6-output. In some implementations, a value range of N1, N2, N4, N5 and N6 is [8,12].

In some embodiments, the third conversion circuit 570 sequentially converts a plurality of pieces of input data in the input data set into index values of the plurality of pieces of input data. The first control terminal group 5113 sequentially inputs the index values of the plurality of pieces of input data in the input data set into the first logic circuit 5111. The first logic circuit 5111 outputs, in response to the index values, corresponding exponential function values from the first output terminal group 5114.

The adder 530 performs an addition operation on the plurality of exponential function values corresponding to the plurality of pieces of input data outputted by the first output end group 5114, to obtain an addition operation result of the plurality of exponential function values.

The first conversion circuit 540 is configured to convert the addition operation result to a corresponding index value.

The second control terminal group 5123 inputs the index values of the plurality of pieces of input data in the input data set outputted by the third conversion circuit 570 into the second basic lookup table circuit unit 512. The second logic circuit 5121 responds to the index values inputted from the second control terminal group 5123 and outputs a corresponding reciprocal of the exponential function from the second output terminal group 5124.

The multiplier 550 multiplies the reciprocal of the exponential function value corresponding to the i^{th} input data outputted by the second output terminal group 5124 and the converted data corresponding to the addition operation result outputted by the first conversion circuit 540, to obtain a multiplication operation result.

The second conversion circuit 560 converts the multiplication operation result into an index value of the multiplication operation result.

The third control terminal group 5133 inputs the index value of the multiplication operation result outputted by the second conversion circuit 560 into the third basic lookup table circuit unit 513. In response to the index value inputted from the third control terminal group 5133, the third logic circuit 5131 outputs the reciprocal corresponding to the index value of the multiplication operation result from the third output terminal group 5134, so as to obtain a Softmax value corresponding to the i^{th} input data.

In some embodiments, time-division multiplexing may also be used to further reduce the dependence of the lookup table on a large storage space and/or on a plurality of basic lookup table circuit units.

Specifically, the lookup table circuit includes: a reusable storage area and/or a reusable basic lookup table circuit unit.

In some embodiments, the storage area is configured to store any one of the first lookup table, the second lookup table, or the third lookup table in each of a plurality of time periods.

The basic lookup table circuit unit comprises a logic circuit, an input terminal group, a control terminal group, and an output terminal group, wherein the input terminal group is connected to the storage area. The logic circuit is configured to: in response to an index value that is of data and that is inputted from the control terminal group, output, based on a corresponding lookup table, data corresponding to the index value of the data from the output terminal group in each of a plurality of time periods.

For example, the logic circuit responds, in the first time period, to the first index value that is of the i^{th} element in the input data set and that is inputted from the control terminal group, and output, based on the first lookup table, the exponential function value corresponding to the i^{th} element from the output terminal group. For example, the logic circuit responds, in the second time period, to the second index value that is of the i^{th} element in the input data set and that is inputted from the control terminal group, and output, based on the second lookup table, the reciprocal of the exponential function value corresponding to the i^{th} element from the output terminal group. For example, the logic circuit unit responds, in the third time period, to the index value that is of the multiplication operation result and that is inputted from the control terminal group, and output, based on the third lookup table, the specific function value corresponding to the index value of the multiplication operation result from the third output terminal group.

The first lookup table, the second lookup table and the third lookup table are written into the storage area by the processor during the compilation period corresponding to the first period, the second period and the third period respectively. For example, when the basic lookup table circuit needs to use the first lookup table, the processor writes the first lookup table into the storage area. Since only one storage area needs to be configured to store any one of the first lookup table, the second lookup table and the third lookup table in time division, the space occupied by the storage area on the hardware acceleration circuit is effectively reduced, and the hardware costs is reduced. It may be understood that in another embodiment, the first lookup table, the second lookup table and the third lookup table may be independently configured in three storage areas.

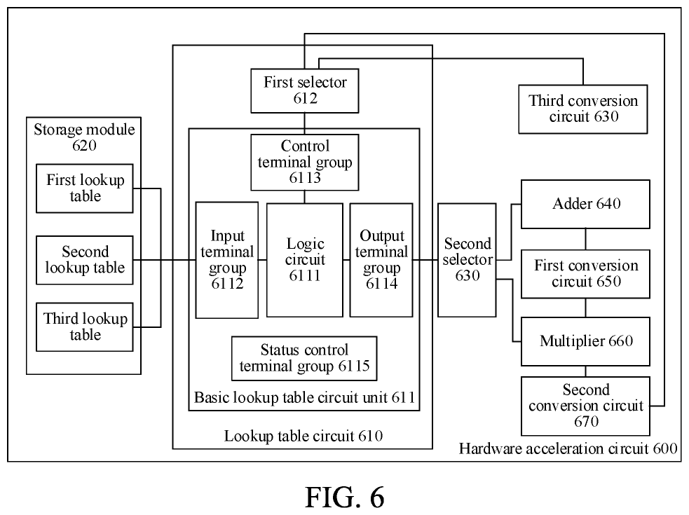

Referring to FIG. 6, a hardware acceleration circuit 600 includes a storage module 620, a lookup table circuit 610, an adder 640, a multiplier 660, a first conversion circuit 650, and a second conversion circuit 670, and a third conversion circuit 630. This embodiment and the hardware acceleration circuit 400 shown in FIG. 5 are similar, and a difference is as follows:

The lookup table circuit 610 includes a basic lookup table circuit unit 611.

The basic lookup table circuit unit 611 includes a logic circuit 6111, an input terminal group 6112, a control terminal group 6113, and an output terminal group 6114. The input terminal group 6112 is connected to the storage module 620, and the logic circuit 6111 is configured to: respond to a first index value of the i^{th} input data inputted from the control terminal group 6113 in the first time period (where the first index value is obtained after the third conversion circuit 630 converts the i^{th} input data), and outputs an exponential function value corresponding to the i^{th} input data from the output terminal group 6114 based on the first lookup table. In the second time period before or after the first time period, in response to a second index value of the i^{th} input data inputted from the control terminal group 6113, the reciprocal of the corresponding exponential function value corresponding to the second index value is outputted from the output terminal group 6114 based on the second lookup table. In the third time period after the second time period, in response to the index value of the multiplication operation result inputted from the control terminal group 6113, the reciprocal of the index value of the multiplication operation result corresponding to the index value of the multiplication operation result is outputted from the output terminal group 6114 based on the third lookup table, that is, the specific function value.

Because only one storage area needs to be configured to store any one of the first lookup table, the second lookup table, and the third lookup table in a time-sharing manner, a storage space occupied by the lookup tables is effectively reduced, and hardware costs can be reduced.

In addition, the hardware acceleration circuit 600 further includes a first selector 6113 and a second selector 630. The first selector 6113 is configured to selectively input the first index value and the second index value of the i^{th} element outputted by the third conversion circuit 630 to the control terminal group 6113, and input, into the control group 6113, the index value of the multiplication operation result outputted by the second conversion circuit 670. The second selector 630 is configured to selectively transmit the data outputted by the output terminal group 6114 to the adder 640 or the multiplier 660.

By reusing the basic lookup table circuit unit, it is necessary to configure only one basic lookup table circuit, so that the area and costs of the lookup table circuit can be effectively reduced.

In some embodiments, a bit width of output data of the first lookup table, the second lookup table, and the third lookup table ranges from 8 to 12. In some embodiments, a bit width of output data of the second lookup table is greater than a bit width of output data of the first lookup table and/or the third lookup table.

It may be understood that, in some specific embodiments, the basic lookup table circuit unit may be configured to have input states with different bit widths and/or output states with different bit widths in different periods, to adapt to a situation where bit widths of input or output data of the first lookup table, the second lookup table, and the third lookup table are different.

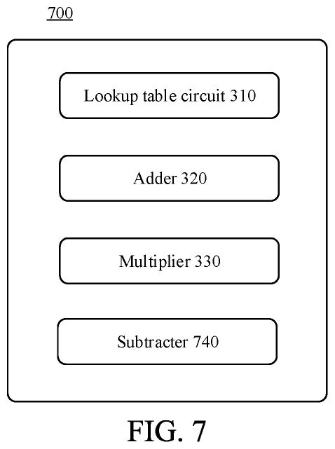

Referring to FIG. 7, in addition to the lookup table circuit 310, the adder 320, and the multiplier 330, a hardware acceleration circuit 700 may further include a subtractor 740.

The subtractor 740 is configured to output a subtraction operation result of an i^{th} element in an initial data set and a maximum value (max) in the initial data set, to obtain the input data set.

Referring to formula (1) and formula (2), when the specific function is a Softmax function, parameters of the function include: xᵢ-xₘₐₓ, and xₖ-xₘₐₓ. i and k are integers greater than or equal to 0, and values of i and k may be the same or different. To facilitate the determination of values of the two parameters, a subtraction operation may be performed by the subtractor arranged on the hardware acceleration circuit.

In some embodiments, precision of the obtained specific function value may be further improved by setting formats of at least part of data, or reducing dependence of the hardware acceleration circuit on larger storage space, or controlling the area and costs of the lookup table circuit.

For example, the i^{th} element in the input data set is data of a bit width of N1 bits, where the data of N1 bits comprises an integer of a bit width of M1 bits and a decimal of a bit width of M2 bits. A sum of M1 and M2 may be equal to N1. For example, when N1 is 8, M1 may be 3, 4, 5, 6, 7, 8, or the like. For example, M1 may be greater than M2 to ensure there are enough integer bits.

The exponential function value corresponding to the i^{th} element is data whose bit width is N2 bits, wherein the N2-bit data comprises an integer whose bit width is M3 bits and a decimal whose bit width is M4 bits. A sum of M3 and M4 may be equal to N2. For example, when N2 is 8, then M4 may be 3, 4, 5, 6, 7, 8, or the like. For example, M3 may be less than M4. It may be understood that, through the foregoing subtraction operation by the subtractor, a value of each element in the input data set is a negative value, and exponential function values of the data elements using e as the base may be normalized into a range of (0, 1]. For example, M3 may be 0, and M4 is equal to N2, to obtain sufficient precision.

It is to be noted that, the first conversion circuit can be configured to replace the addition operation result outputted by the adder with data with a bit width of N3 bits and fewer bits, to perform subsequent multiplication operations. The conversion can avoid a problem of an excessive operation amount of the multiplier when a bit width of data outputted by the adder is to wide. The first conversion circuit may include, for example, a shift circuit, and the like. The converted data may be captured from a designated position of the data before conversion. N3-bit data includes an integer whose bit width is M5 bits and a decimal whose bit width is M6 bits. A sum of M5 and M6 may be equal to N3. For example, when N3 is 8, M5 may be 3, 4, 5, 6, 7, 8, or the like. For example, M5 may be greater than M6, to ensure that there are enough integer places to represent an addition operation result with a larger range.

It may be understood that values of any two of M1, M2, M3, M4, M5 and M6 are the same or different. A specific value may be set according to a value range of the represented data. For example, if a value range of an integer part of the represented data is smaller, more decimal places may be allocated for greater data precision. For example, if the data range of the integer part of the represented data is larger, more integer places may be allocated.

In some embodiments, N1, N2 and N3 may take values from 8, 9, 10, 11 or 12, and the three may be the same or different. In a specific embodiment, N1, N2, and N3 may be 8, which reduces the dependence on large-size storage space, reduces the space occupied by the hardware acceleration circuit, reduces the cost, and is more compatible with commonly used 8-bit hardware circuits. M1, M2, M3, M4, M5 and M6 are 5, 3, 0, 8, 7 and 1 respectively. This can avoid the data digits being too wide while satisfying precision requirements for the data of the i^{th} element, the corresponding exponential function value corresponding to the i^{th} element, and the addition operation result.

In some embodiments, the reciprocal of the exponential function value corresponding to the second index value of the i^{th} element is data whose bit width is N4 bits, wherein the N4-bit data comprises an integer whose bit width is M7 bits and a decimal whose bit width is M8 bits. N4 may be 6, 8, 9, 10, 12, 14, 16, or the like. A sum of M7 and M8 may be equal to N4. For example, when N4 is 10, M7 may be 3, 4, 5, 6, 7, 8, 9, 10, or the like. For example, M7 may be greater than M8. For example, M8 is 0, and M7 is equal to N4. When the exponential function value is normalized to the range of (0, 1], the reciprocal value is greater than 1, the value range is larger, and it may be involved in subsequent multiplication operations, and therefore its decimal place can be ignored.

In some embodiments, the second conversion circuit is configured to convert the multiplication operation result outputted by the multiplier into data with a bit width of N5 bits with fewer digits. The second conversion circuit may include, for example, a shift circuit, and the like. The converted data may be captured from a designated position of the data before conversion. N5-bit data includes an integer whose bit width is M9 bits and a decimal whose bit width is M10 bits. N5 may be 6, 8, 9, 10, 12, 14, 16, or the like. A sum of M9 and M10 may be equal to N5. For example, when N5 is 12, M7 may be 5, 6, 7, 8, 9, 10, 11, 12, or the like. In some embodiments, M9 is greater than M10, to ensure that there are enough integer places to represent a multiplication operation result with a larger range.

In some embodiments, the specific function value corresponding to the index value of the multiplication operation result is data of a bit width of N6 bits, wherein the data of N6 bits comprises an integer of a bit width of M11 bits and a decimal of a bit width of M12 bits. A sum of M11 and M12 may be equal to N2. For example, when N6 is 8, M12 may be 3, 4, 5, 6, 7, 8, or the like. In some embodiments, M11 is less than M12. It may be understood that an output of the specific function value LUT is the reciprocal of the multiplication operation result, and its value range is in a range of (0, 1]. Therefore, in a specific embodiment, M11 may be 0, and M12 is equal to N6, to obtain sufficient precision.

In some embodiments, a third conversion circuit is configured to convert the i^{th} element in the input data set into an index value. For example, the i^{th} element is converted into 8-bit data. In order to ensure precision, the 8-bit data may include 3 decimal places. The third conversion circuit may include a shift circuit.

Because a dynamic range of Softmax function values is very wide, the function is mostly implemented using a software module in the related technology. This embodiment of this application provides the solution basically based on an 8-bit hardware circuit and can effectively balance important indicators of the circuit such as costs, power consumption, bandwidth, performance, and data precision.

Another aspect of this application further provides a data processing acceleration method.

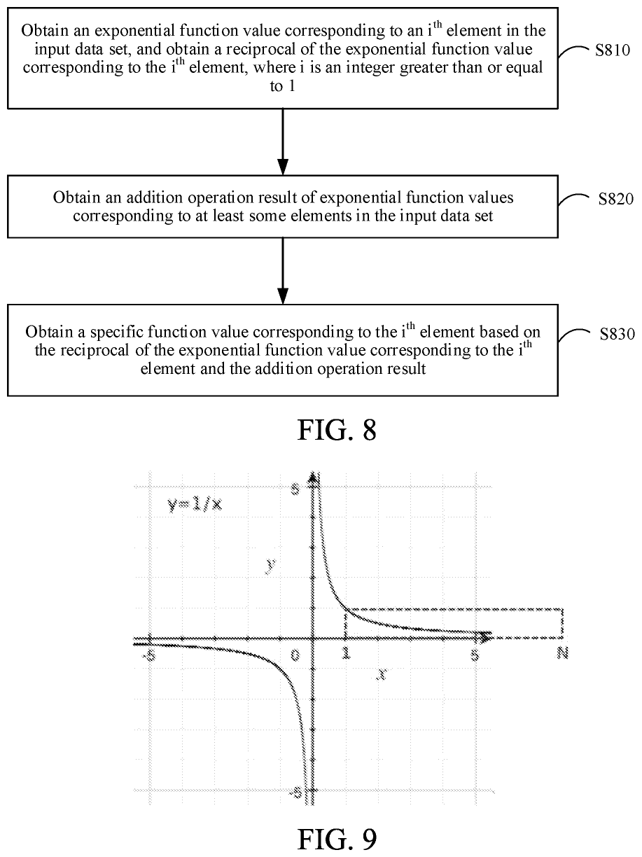

FIG. 8 is a schematic flowchart of a data processing acceleration method according to an embodiment of this application.

Referring to FIG. 8, the data processing acceleration method may include step S810 to step S830.

In step S810, an exponential function value corresponding to an i^{th} element in the input data set is obtained, and a reciprocal of the exponential function value corresponding to the i^{th} element is obtained, where i is an integer greater than or equal to 1.

In this embodiment, the exponential function value corresponding to the i^{th} element in the input data set may be obtained through a lookup table, an arithmetic circuit, or external data. For example, the exponential function value corresponding to the i^{th} element may be determined based on a lookup table stored in the hardware acceleration circuit of the artificial intelligence chip. For example, the artificial intelligence chip can send the i^{th} element to the processor, and the processor calculates the exponential function value corresponding to the i^{th} element, and sends the exponential function value corresponding to the i^{th} element to the artificial intelligence chip. For example, the exponential function value corresponding to the i^{th} element may be determined based on a logical operation circuit provided on the hardware acceleration circuit. Similarly, the reciprocal of the exponential function value corresponding to the i^{th} element may be obtained through a lookup table, an arithmetic circuit, and the like.

In step S820, an addition operation result of exponential function values corresponding to at least some elements in the input data set is obtained.

For example, an adder may be used to perform am addition operation on exponential function values corresponding to at least some elements in the input data set, to obtain an addition operation result. In addition, an addition operation may alternatively be performed by a CPU or the like.

In step S830, a specific function value corresponding to the i^{th} element is obtained based on the reciprocal of the exponential function value corresponding to the i^{th} element and the addition operation result.

In this embodiment, the specific function may be a non-linear function, and the non-linear function may be expressed using an exponential function. The specific function includes but is not limited to a Softmax function, a Sigmoid function, a TanH function, and the like. For example, for the expression of the Softmax function, reference may be made to formula (1) and formula (2). Taking formula (2) as an example, an inverse operation is performed on the Softmax function, then in step S530, it is necessary to perform a multiplication operation on the reciprocal of the exponential function value corresponding to the i^{th} element and the addition operation result to obtain a multiplication operation result, and then an inverse operation is performed on the multiplication operation result.

FIG. 9 is a schematic diagram of an inverse operation according to an embodiment of this application.

FIG. 9 is a graph for a function y=1/x. When x is greater than zero, a larger value of x indicates a smaller value of the function y. An inverse operation of the Softmax function corresponding to the i^{th} element may be expressed as:

$$\frac{1}{{σ ( x )}_{i}} .$$

A larger value of

$$\frac{1}{{σ ( x )}_{i}}$$

indicates a smaller value of σ(x)ᵢ. A function value of σ(x)ᵢ may be in a range of 1 to N, where N is an integer greater than 1. In some scenarios, more attention is paid to a case is too large in which σ(x)ᵢ approaches 1. Therefore, a situation where a value of

$$\frac{1}{{σ ( x )}_{i}}$$

is too large may be ignored, and more storage space is left for a situation in which σ(x)ᵢ approaches 1, which helps to improve accurately of the determined Softmax function value.

It is to be noted that, at least part of the multiplication operation result and the inverse operation result may be determined by the processor executing corresponding operation logic. In addition, at least part of the multiplication operation result and the inverse operation result may also be determined by the hardware accelerator through a lookup table.

In some embodiments, the obtaining a specific function value corresponding to the i^{th} element based on the reciprocal of the exponential function value corresponding to the i^{th} element and the addition operation result may include the following operations. First, a multiplication operation result of the reciprocal of the exponential function value corresponding to the i^{th} element and the addition operation result is obtained. Then, the reciprocal of the multiplication operation result is obtained, to obtain the Softmax function value corresponding to the i^{th} element.

Data A may be data A itself, or may include data obtained after converting the data A. For example, the reciprocal may be data outputted by the lookup table circuit, or may be data converted from the data outputted by the lookup table circuit. For example, the multiplication operation result is 32-bit data, and in order to reduce the entries of the LUT, the 32-bit data may be converted into data with smaller bit width.

In some embodiments, the obtaining the exponential function value corresponding to the i^{th} element in the input data set includes: obtaining the exponential function value corresponding to the i^{th} element in the input data set by using a first mapping relationship pre-stored in the lookup table module. The first mapping relationship may be configured in the hardware acceleration circuit in a form of a first lookup table.

In some embodiments, the obtaining the reciprocal of the exponential function value corresponding to the i^{th} element includes: obtaining the reciprocal of the exponential function value corresponding to the i^{th} element by using a second mapping relationship pre-stored in the lookup table module. The second mapping relationship may be configured in the hardware acceleration circuit in a form of a second lookup table.

In some embodiments, the obtaining the reciprocal of the multiplication operation result to obtain a Softmax function value corresponding to the i^{th} element includes: obtaining the reciprocal of the multiplication operation result by using a third mapping relationship pre-stored in the lookup table module, to obtain the Softmax function value corresponding to the i^{th} element. The third mapping relationship may be configured in the hardware acceleration circuit in a form of a third lookup table.

In some embodiments, before the obtaining an exponential function value corresponding to an i^{th} element in an input data set, the foregoing method may further include the following operations. A subtraction operation is performed on the i^{th} element in the initial data set and a maximum value in the initial dataset to obtain the i^{th} element in the input data set.

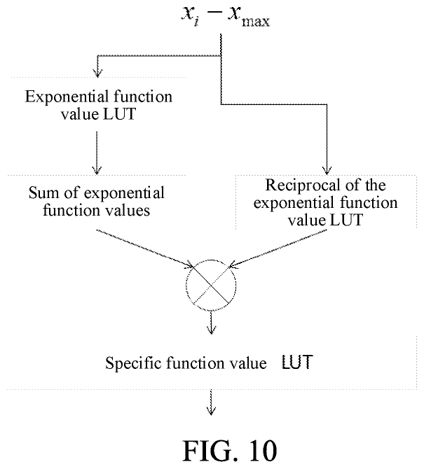

FIG. 10 is a logic diagram of a data processing acceleration method according to an embodiment of this application;

Referring to FIG. 10, in combination with formula (2), the Softmax function is transformed to obtain two parts: a sum of exponential functions e^{x} and a reciprocal of the exponential function e^{x}.

For example, formula transformation is performed on the Softmax function, a range of the exponential function e^{x} is changed to (0, 1], and correspondingly, a value range of x is [−10, 0]. The range of x is split into 256 points, and an exponential function value for each point is calculated. This quantizes all these results to map them into a range [0, 1]. All these quantized values are filled into the exponential function value LUT, and the exponential function value is pre-stored in an 8-bit to 8-bit LUT.

This allows the exponential function value to be searched in the pre-stored exponential function value LUT based on the value of x. For example, the exponential function values corresponding to at least some (such as all) elements xᵢ-xₘₐₓ in the array are found in the exponential function value LUT through a look-up table method.

Next, an accumulator can be used to add exponential function values corresponding to all elements xᵢ-xₘₐₓ in the array to obtain an accumulated value of the exponential function values of all elements xᵢ-xₘₐₓ in a 32-bit format.

Then, perform data conversion on the accumulated value in the 32-bit format to obtain an accumulated value represented by N bits.

Referring to FIG. 10, the reciprocal of the exponential function value may also be searched in the reciprocal of the exponential function value LUT.

Then, the accumulated value of the exponential function values is multiplied by the reciprocal of the exponential function value through a multiplier to obtain the reciprocal of the specific function value. For example, the multiplier performs a multiplication operation on an 8-bit accumulated value of the exponential function values and a 10-bit reciprocal of the exponential function value to obtain an X-bit reciprocal of the Softmax function value. X may be 8, 12, 16, 32, or the like.

Then, the reciprocal of the specific function value may be used to search for the Softmax function value in a pre-stored X-bit to 8-bit specific function value LUT.

It is to be noted that, although 3 LUTs are involved in FIG. 10, a quantity of entries included in the 3 small LUTs (such as an 8-bit to 8-bit LUT) is far less than a quantity of entries included in one large table (such as a 16-bit LUT).

In a specific embodiment, an exponential function value LUT may be an 8-bit to 8-bit LUT, including 256 entries. A reciprocal of the exponential function value LUT may be an 8-bit to 10-bit format LUT, including 1024 entries. A specific function value LUT may be a 12-bit to 8-bit format LUT, including 4096 entries. The 3 LUTs include a total of 5376 entries. One LUT in 16-bit format includes 65536 entries. Therefore, the quantity of entries included in the LUT is greatly reduced, which can effectively reduce the hardware costs, and met precision requirements.

For example, using a COCO2017 data set, when a Detection Transformer neural network with 6 layers of encoders+6 layers of decoders runs the technical solution shown in the previous specific embodiment, mean average precision (Mean Average Precision, mAP for short) is 35.2. Based on the above, this embodiment can effectively reduce the LUT's dependence on large-sized storage space on the basis of meeting precision requirements.

In the embodiment of this application, an inverse operation is performed on a specific function (such as the Softmax function), so that a LUT with fewer bits can be used, and power consumption, bandwidth, performance, and precision of implementing the specific function on hardware can be balanced to meet the requirements for the neural network.

In order to further reduce the dependence on large storage space for intermediate results generated in the process of storing lookup tables or storing determined function values, a specific data format can be adopted for data storage.

In some embodiments, the i^{th} element in the input data set, the exponential function value corresponding to the i^{th} element in the input data set, and the addition operation result have the same bit width. For example, storage space with 8 bits may be used to store the i^{th} element, the exponential function value corresponding to the i^{th} element in the input data set, and the addition operation result.

After performing a reciprocal operation on the exponential function value, a bit width of the reciprocal of the exponential function value corresponding to the i^{th} element may be set according to the requirement for data precision. In some embodiments, in order to improve precision of the obtained Softmax function value, storage space with more digits may be used to store the reciprocal. Specifically, the bit width of the reciprocal of the exponential function value corresponding to the i^{th} element is greater than the bit width of the i^{th} element in the input data set. For example, the bit width of the i^{th} element may be 8 bits, and the bit width of the reciprocal may be greater than 8 bits to improve precision. For example, the bit width of the reciprocal may be 8 bits, 9 bits, 10 bits, 12 bits, 13 bits, 14 bits, or the like.

In addition, the quantity of digits and the quantity of decimal places may be included in the data format. For example, the format of Q5.3 may be used to represent 8-bit data, including a 5-bit integer and a 3-bit decimal. When storing data for a certain parameter, decimal place information may be determined directly based on the data format set for the parameter without storing the decimal place information.

In some embodiments, the bit width of the i^{th} element is equal to the bit width of the specific function value corresponding to the i^{th} element. For example, both the bit width of the i^{th} element and the bit width of the specific function value may be 8 bits, or the like.

In order to convert an intermediate result or a specific function value into a preset data format, it can be realized by shifting. For example, if the intermediate result is 32 bits and the data format of the intermediate result is 8 bits, then the 8 bits starting from the highest bit of the intermediate result can be taken, and remaining bits of data may be discarded.

For example, after obtaining the specific function value corresponding to the i^{th} element, the bit width of the specific function value is converted. If the specific function value is 12 bits, 8 bits may be captured from the specific function value.

In some embodiments, the i^{th} element is data whose bit width is N1 bits, wherein the N1-bit data comprises an integer whose bit width is M1 bits and a decimal whose bit width is M2 bits; The exponential function value corresponding to the i^{th} element is data whose bit width is N2 bits, wherein the N2-bit data comprises an integer whose bit width is M3 bits and a decimal whose bit width is M4 bits. The addition operation result is data of a bit width of N3 bits, where the data of N3 bits includes an integer of a bit width of M5 bits and a decimal of a bit width of M6 bits.

Any two values of M1, M2, M3, M4, M5 and M6 are the same or different. For example, N1, N2, and N3 are all 8. M1, M2, M3, M4, M5 and M6 have different values. For example, values of M1 to M12 include at least one of the following: M1 is greater than M2, M3 is less than M4, M5 is greater than M6, M7 is greater than M8, M9 is greater than M10, M11 is less than M12, M9 is greater than or equal to M5, M9 is less than or equal to M7, M10 is greater than or equal to M6, and M10 is greater than or equal to M8.

In some embodiments, the bit width of the reciprocal of the exponential function value corresponding to the i^{th} element is greater than a bit width of the i^{th} element in the input data set.

In some embodiments, the bit width of reciprocal of the exponential function value corresponding to the i^{th} element is greater than a bit width of the exponential function value corresponding to the i^{th} element and a bit width of the specific function value.

In some embodiments, the bit width of the i^{th} element is equal to the bit width of the specific function value corresponding to the i^{th} element.

For example, to ensure data precision of the i^{th} element of inputted and reduce the risk of saturation, M1 may be set to 5, and M2 may be set to 3. The exponential function value corresponding to the i^{th} element is usually a decimal, and a quantity format of the exponential function value may be set to have a plurality of decimal places to improve data precision. For example, the format of the exponential function value may be Q0.8. An accumulated value of the plurality of exponential function values is relatively large. M5 may be set to be greater than M3, or M5 may be set to be greater than M1. In addition, to ensure precision of the accumulated value of the plurality of exponential function values, the decimal places may be set, for example, M6 is set to 1, 2, 3, or the like.

In some embodiments, the reciprocal of the exponential function value corresponding to the i^{th} element is data whose bit width is N4 bits, wherein the N4-bit data comprises an integer whose bit width is M7 bits and a decimal whose bit width is M8 bits. Values of any two of M1, M2, M7, and M8 are the same or different. For example, the exponential function value corresponding to the i^{th} element has a wider value range, and more entries need to be used to improve precision of the reciprocal obtained through table lookup. For example, the reciprocal of the exponential function value LUT is a 10-bit to 8-bit LUT, a 12-bit to 8-bit LUT, or a 14-bit to 8-bit LUT. In addition, the reciprocal of the exponential function value corresponding to the i^{th} element is mainly distributed in an interval greater than 1, and in this case, only the integer places can be set and the decimal places are not set.

In some embodiments, the multiplication operation result is data whose bit width is N5 bits, wherein the N5-bit data comprises an integer whose bit width is M9 bits and a decimal whose bit width is M10 bits.

For example, M9 is greater than or equal to M5, M9 is less than or equal to M7, M10 is greater than or equal to M6, and M10 is greater than or equal to M8. After performing a multiplication operation, to improve numerical precision of the result, more digits may be allocated to the multiplication operation result. For example, a quantity of digits in the multiplication operation result can be greater than or equal to a quantity of digits in the accumulated value of the specific function value or a quantity of digits in the reciprocal of the exponential function value. In addition, to reduce the entries included in the LUT to reduce hardware costs, the quantity of digits in the multiplication operation result should not be too large. For example, a quantity of digits in the multiplication operation result may be 10 bits, 12 bits, 14 bits, or the like. The quantity of digits in the multiplication operation result may include integer places and decimal places.

In some embodiments, a bit width of the multiplication operation result is greater than a bit width of the reciprocal of the exponential function value corresponding to the i^{th} element and/or a bit width of the addition operation result. This improves precision of the multiplication operation result.

In some embodiments, the reciprocal of the multiplication operation result is data of a bit width of N6 bits, where the data of N6 bits includes an integer of a bit width of M11 bits and a decimal of a bit width of M12 bits. M11 is less than M1, M11 is less than M9, M12 is greater than M2, and M12 is greater than M10. For example, N6 may be 8 bits, 10 bits, 12 bits, or the like.

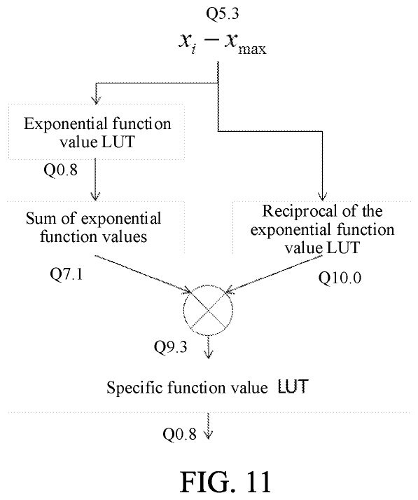

FIG. 11 is a schematic diagram of formats of data in a process of performing a data processing acceleration method according to an embodiment of this application.

Referring to FIG. 11, a value of xᵢ-xₘₐₓ may be in a Q5.3 format, an output value of the exponential function value LUT may be in a Q0.8 format, an accumulated value of the exponential function values may be in a Q7.1 format, and an output of the reciprocal of the exponential function value LUT may be in a Q10.0 format, the multiplication operation result can be in a Q9.3 format, and an output value of the specific function value LUT may be in a Q0.8 format.

It is to be noted that, the foregoing formats are only illustrative descriptions, other formats may also be used according to precision requirements, and should not be understood as limitations on this application.

For related features of the data processing acceleration method in this embodiment of this application, reference may be made to related content in the embodiment of the foregoing hardware acceleration circuit. Details are not described again.

Corresponding to the foregoing application function implementation method embodiments, this application further provides a data processing acceleration apparatus, an electronic device, and corresponding embodiments.

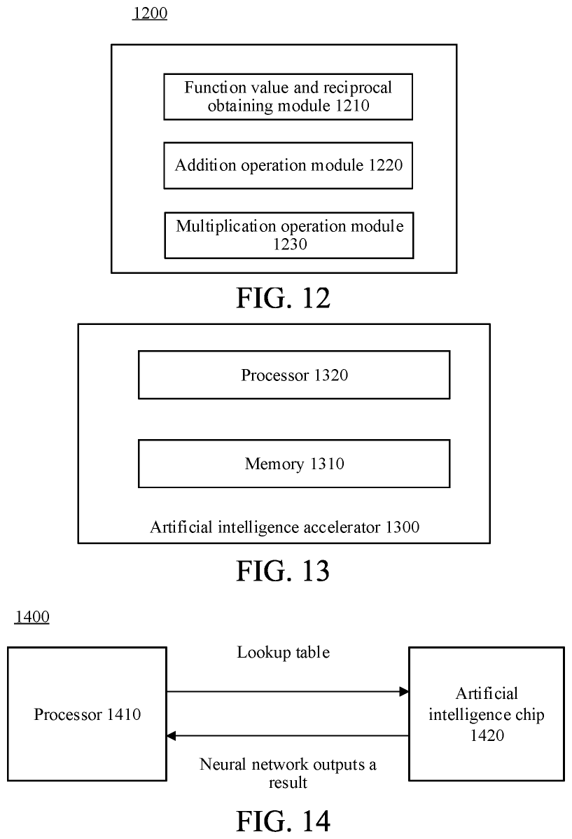

FIG. 12 is a schematic structural diagram of a data processing acceleration apparatus according to an embodiment of this application.

Referring to FIG. 12, the data processing acceleration apparatus 1200 includes a function value and reciprocal obtaining module 1210, an addition operation module 1220, and a multiplication operation module 1230.

The function value and reciprocal obtaining module 1210 is configured to obtain an exponential function value corresponding to an i^{th} element in the input data set, and obtaining a reciprocal of the exponential function value corresponding to the i^{th} element, wherein i is an integer greater than or equal to 1.

The addition operation module 1220 is configured to obtain an addition operation result of exponential function values corresponding to at least some elements in the input data set.

The multiplication operation module 1230 is configured to obtain a specific function value corresponding to the i^{th} element based on the reciprocal of the exponential function value corresponding to the i^{th} element and the addition operation result.

For the apparatuses in the foregoing embodiments, a specific manner in which each module performs an operation is already described in detail in the embodiments related to the method, and details are not described herein again.

The data processing acceleration method according to the embodiments of this application is applicable to an artificial intelligence accelerator.

FIG. 13 is a schematic structural diagram of an artificial intelligence accelerator according to an embodiment of this application. Referring to FIG. 13, the artificial intelligence accelerator 1300 includes: a memory 1310 and a processor 1320.

The artificial intelligence accelerator 1320 may be a general-purpose processor such as a CPU (central processing unit), or may be an intelligence processing unit (IPU) configured to execute an artificial intelligence operation. The artificial intelligence operation may include a machine learning operation, a brain-like operation, and the like. The machine learning operation includes a neural network operation, a k-means operation, a support vector machine operation, and the like. The intelligence processing unit may include, for example, one of a GPU (graphics processing unit), a DLA (deep learning accelerator), an NPU (Neural-Network Processing Unit, neural network processing unit), a DSP (digital signal processor), a field-programmable gate array (field-programmable gate array, FPGA), and an application-specific integrated circuit (application-specific integrated circuit, ASIC) or a combination thereof. A specific type of the processor is not limited in this application.

The memory 1310 may include various types of storage units, for example, a system memory, a read-only memory (ROM), and a permanent storage apparatus. The ROM may store static data or instruction required by the processor 1320 or another module of a computer. The permanent storage apparatus may be a readable/writable storage apparatus. The permanent storage apparatus may be a non-volatile storage device that does not lose stored instructions and data even if the computer is powered off. In some implementations, a mass storage apparatus (for example, a magnetic disk, an optical disc, or a flash memory) is used as the permanent storage apparatus. In some other implementations, the permanent storage apparatus may be a removable storage device (for example, a floppy disk or an optical disc drive). The system memory may be a readable/writable storage device or a volatile readable/writable storage device, for example, a dynamic random access memory. The system memory may store some or all instructions and data required by the processor during running. Moreover, the memory 1310 may include any combination of computer-readable storage mediums, including various types of semiconductor storage chips (for example, a DRAM, an SRAM, an SDRAM, a flash memory, and a programmable read-only memory), and a magnetic disk and/or an optical disc may alternatively be used as the memory. In some implementations, the memory 1310 may include a readable and/or writable removable storage device, for example, a compact disc (CD), a read-only digital versatile disc (for example, a DVD-ROM or a double-layer DVD-ROM), a read-only Blu-ray disc, an ultra-density optical disc, a flash memory card (for example, an SD card, a min SD card, or a Micro-SD card), a magnetic floppy disk, and the like. The computer-readable storage medium does not include a carrier and an instantaneous electronic signal transmitted in a wireless or wired manner.

Executable code is stored on the memory 1310. When the executable code is processed by the processor 1320, the processor 1320 is enabled to execute part or all of the foregoing method.

In a possible implementation, the artificial intelligence accelerator may include a plurality of processors, and various assigned tasks may be independently run on each processor. The processor and the tasks run on the processor are not limited in this application.

It may be understood that, unless otherwise specified, functional units/modules in the embodiments of this application may be integrated into one unit/module, or each unit/module may exist alone physically, or two or more units/modules are integrated together. The foregoing integrated unit/module may be implemented in a form of hardware, or may be implemented in a form of a software program module.

If the integrated unit/module is implemented in a form of hardware, the hardware may be a digital circuit, an analog circuit, or the like. A physical implementation of the hardware structure includes but is not limited to a transistor, a memristor, or the like. Unless otherwise specified, the intelligence processing unit may be any proper hardware processor, for example, a CPU, a GPU, an FPGA, a DSP, or an ASIC. Unless otherwise specified, the storage module may be any proper magnetic disk storage medium or magnetic disk optical storage medium, for example, a resistive memory RRAM (Resistive Random Access Memory), a dynamic random access memory DRAM (Dynamic Random Access Memory), a static random access memory SRAM (Static Random Access Memory), an enhanced dynamic random access memory EDRAM (Enhanced Dynamic Random Access Memory), a high-bandwidth memory HBM (High-Bandwidth Memory), or a hybrid memory cube HMC (Hybrid Memory Cube).

When the integrated unit/module is implemented in the form of a software program module and sold or used as an independent product, the integrated module may be stored in a computer-readable memory. Based on such an understanding, the technical solutions of this application essentially, or the part contributing to the prior art, or all or some of the technical solutions may be implemented in a form of a software product. The computer software product is stored in a memory, and includes several instructions for instructing a computer device (which may be a personal computer, a server, or a network device) to perform all or some of the steps of the methods described in the embodiments of this application. The foregoing memory includes any medium that can store program code, such as a USB flash drive, a read-only memory (ROM, Read-Only Memory), a random access memory (RAM, Random Access Memory), a removable hard disk, a magnetic disk, or an optical disc.

In a possible implementation, an artificial intelligence chip is further disclosed, including the foregoing hardware acceleration circuit.

In a possible implementation, a card is further disclosed, including a storage device, an interface apparatus, a control device, and the foregoing artificial intelligence chip. The artificial intelligence chip is connected to each of the storage device, the control device, and the interface apparatus; the storage device is configured to store data; the interface apparatus is configured to implement data transmission between the artificial intelligence chip and an external device; and the control device is configured to monitor a status of the artificial intelligence chip.

In a possible implementation, an electronic device is disclosed, including the foregoing artificial intelligence chip. The electronic device includes a data processing apparatus, a robot, a computer, a printer, a scanner, a tablet computer, an intelligent terminal, a mobile phone, an event data recorder, a navigator, a sensor, a webcam, a server, a cloud server, a camera, a video camera, a projector, a watch, a headset, a portable storage, a wearable device, a transportation means, a household appliance, and/or a medical device. The transportation means includes an airplane, a steamship, and/or a vehicle; the household appliance includes a television set, an air conditioner, a microwave stove, a refrigerator, an electric cooker, a humidifier, a washing machine, an electric lamp, a gas stove, and a range hood; and the medical device includes a nuclear magnetic resonance spectrometer, a B-mode ultrasonic instrument, and/or an electrocardiogramachine.

FIG. 14 is a schematic structural diagram of an electronic device according to an embodiment of this application.

Referring to FIG. 14, an electronic device 1400 includes a processor 1410 and an artificial intelligence chip 1420.

The processor 1410 is configured to send at least one of a first lookup table, a second lookup table, or a third lookup table to the artificial intelligence chip 1420, where the first lookup table is used for implementing a first mapping relationship between an i^{th} element in an input data set and an exponential function value, the second lookup table is used for implementing a second mapping relationship between the i^{th} element in the input data set and a reciprocal of the exponential function value. The third lookup table is used for implementing a third mapping relationship between a multiplication operation result and a reciprocal of the multiplication operation result, the multiplication operation result being a result obtained by performing a multiplication operation on the reciprocal of the exponential function value corresponding to the i^{th} element and an addition operation result, and the addition operation result being an addition operation result of exponential function values corresponding to at least some elements in the input data set.

The artificial intelligence chip 1420 is configured to perform the foregoing method based on at least one of the first lookup table, the second lookup table, or the third lookup table.

The processor 1410 may be a central processing unit (CPU) or a graphics processing unit (GPU), or may be a general purpose processor, a digital signal processor (digital signal processor, DSP), an application-specific integrated circuit (application-specific integrated circuit, ASIC), a field-programmable gate array (field-programmable gate array, FPGA), or another programmable logic device, a discrete gate or a transistor logic device, or a discrete hardware component. The general-purpose processor may be a microprocessor, or the processor may be any conventional processor or the like.

The artificial intelligence chip 1420 may include a fully-connected layer circuit, a loss function layer circuit, and a hardware accelerator as shown above.

The fully-connected layer circuit is configured to transmit the i^{th} element in the input data set to the hardware acceleration circuit, and receive a loss gradient value for the i^{th} element in the input data set from the hardware acceleration circuit.

The loss function layer circuit is configured to transmit, in response to a specific function value from the hardware acceleration circuit, a loss value for the specific function value to the hardware acceleration circuit.

Moreover, the method according to this application may be further implemented as a computer program or computer program product, and the computer program or computer program product includes computer program code instructions used to execute some or all steps in the foregoing method of this application.

Alternatively, this application may be further implemented as a computer-readable storage medium (or a non-transient machine-readable storage medium or a machine-readable storage medium), on which executable code (or computer program or computer instruction code) is stored. When the executable code (or computer program or computer instruction code) is executed by a processor of an electronic device (or server or the like), the processor is enabled to execute some or all of the steps of the foregoing method according to this application.

The embodiments of the present disclosure are described above, and the foregoing descriptions are exemplary but not exhaustive and are not limited to the disclosed embodiments. Without departing from the scope and spirit of the described embodiments, many modifications and variations are apparent to a person of ordinary skill in the technical field. The selected terms used herein is intended to best explain the principles of the embodiments, practical applications, or improvements of technologies in the market, or to enable other persons of ordinary skill in the technical field to understand the embodiments disclosed herein.

What is claimed is:

1. A hardware acceleration circuit, comprising:
a lookup table circuit, configured to: in response to an i^{th} element in an input data set, output an exponential function value corresponding to a first index value of the i^{th} element based on a first lookup table, and/or output a reciprocal of the exponential function value corresponding to a second index value of the i^{th} element based on a second lookup table, wherein i is an integer greater than or equal to 1;
an adder, configured to output an addition operation result of exponential function values corresponding to at least some elements in the input data set; and
a multiplier, configured to output a multiplication operation result of the reciprocal of the exponential function value corresponding to the i^{th} element and the addition operation result, to obtain a reciprocal of a specific function value corresponding to the i^{th} element, and obtain the specific function value corresponding to the i^{th} element.

2. The hardware acceleration circuit according to claim 1, wherein the lookup table circuit is further configured to output, in response to the multiplication operation result, a specific function value corresponding to an index value of the multiplication operation result based on a third lookup table.

3. The hardware acceleration circuit according to claim 2, wherein
the i^{th} element is data whose bit width is N1 bits, wherein the N1-bit data comprises an integer whose bit width is M1 bits and a decimal whose bit width is M2 bits;
the exponential function value corresponding to the i^{th} element is data whose bit width is N2 bits, wherein the N2-bit data comprises an integer whose bit width is M3 bits and a decimal whose bit width is M4 bits; and
the hardware acceleration circuit further comprises: a first conversion circuit, configured to convert the addition operation result into data whose bit width is N3 bits as the addition operation result, wherein the N3-bit data comprises an integer whose bit width is M5 bits and a decimal whose bit width is M6 bits, and values of any two of M1, M2, M3, M4, M5, and M6 are the same or different.

4. The hardware acceleration circuit according to claim 3, wherein
the reciprocal of the exponential function value corresponding to the second index value of the i^{th} element is data whose bit width is N4 bits, wherein the N4-bit data comprises an integer whose bit width is M7 bits and a decimal whose bit width is M8 bits; and
the hardware acceleration circuit further comprises: a second conversion circuit, configured to convert the multiplication operation result into N5-bit data, wherein the N5-bit data comprises an integer whose bit width is M9 bits and a decimal whose bit width is M10 bits.

5. The hardware acceleration circuit according to claim 4, wherein the specific function value corresponding to the index value of the multiplication operation result is data whose bit width is N6 bits, wherein the N6-bit data comprises an integer whose bit width is M11 bits and a decimal whose bit width is M12 bits, and
wherein values of M1 to M12 comprise at least one, or more, or all of the following: M1 is greater than M2; M3 is less than M4; M5 is greater than M6; M7 is greater than M8; M9 is greater than M10; and M11 is less than M12.

6. The hardware acceleration circuit according to claim 2, wherein
a bit width of output data of the first lookup table, the second lookup table, and the third lookup table ranges from 8 to 12; and/or
a bit width of output data of the second lookup table is greater than a bit width of output data of the first lookup table and/or the third lookup table.

7. The hardware acceleration circuit according to claim 2, wherein the lookup table circuit comprises:
a first storage area and a first basic lookup table circuit unit, wherein the first storage area is configured to store the first lookup table, the first basic lookup table circuit unit comprises a first logic circuit, a first input terminal group, a first control terminal group, and a first output terminal group, and the first input terminal group is connected to the first storage area; and the first logic circuit is configured to: output, based on the first lookup table, the exponential function value corresponding to the i^{th} element from the first output terminal group in response to the first index value that is of the i^{th} element in the input data set and that is inputted from the first control terminal group;
and/or
a second storage area and a second basic lookup table circuit unit, wherein the second storage area is configured to store the second lookup table, the second basic lookup table circuit unit comprises a second logic circuit, a second input terminal group, a second control terminal group, and a second output terminal group, and the second input terminal group is connected to the second storage area; and the second logic circuit is configured to output, based on the second lookup table, the reciprocal of the exponential function value of the i^{th} element from the second output terminal group in response to the second index value that is of the i^{th} element in the input data set and that is inputted from the second control terminal group;
and/or
a third storage area and a third basic lookup table circuit unit, wherein the third storage area is configured to store the third lookup table, the third basic lookup table circuit unit comprises a third logic circuit, a third input terminal group, a third control terminal group, and a third output terminal group, and the third input terminal group is connected to the third storage area; and the third logic circuit is configured to output, based on the third lookup table, the specific function value corresponding to the index value of the multiplication operation result from the third output terminal group in response to the index value that is of the multiplication operation result and that is inputted from the third control terminal group.

8. The hardware acceleration circuit according to claim 2, wherein the lookup table circuit comprises:
a storage area, configured to store any one of the first lookup table, the second lookup table, or the third lookup table in each of a plurality of time periods; or a plurality of storage areas, configured to respectively store the first lookup table to the third lookup table; and
a basic lookup table circuit unit, comprising a logic circuit, an input terminal group, a control terminal group, and an output terminal group, wherein the input terminal group is connected to the storage area; and the basic lookup table circuit unit is configured to: in response to an index value that is of data and that is inputted from the control terminal group, output, based on a corresponding lookup table, data corresponding to the index value of the data from the output terminal group in each of a plurality of time periods.

9. The hardware acceleration circuit according to claim 3, further comprising:
a subtractor, configured to output a subtraction operation result of an i^{th} element in an initial data set and a maximum value in the initial data set, to obtain the input data set; and
a third conversion circuit, configured to convert the i^{th} element in the input data set into an index value.

10. An artificial intelligence chip, comprising the hardware acceleration circuit according to claim 1.

11. A data processing acceleration method, applied to an artificial intelligence accelerator, the method comprising:
obtaining an exponential function value corresponding to an i^{th} element in an input data set, and obtaining a reciprocal of the exponential function value corresponding to the i^{th} element, wherein i is an integer greater than or equal to 1;
obtaining an addition operation result of exponential function values corresponding to at least some elements in the input data set; and
obtaining a specific function value corresponding to the i^{th} element based on the reciprocal of the exponential function value corresponding to the i^{th} element and the addition operation result.

12. The method according to claim 11, wherein the specific function value corresponding to the i^{th} element based on the reciprocal of the exponential function value corresponding to the i^{th} element and the addition operation result is obtained by:
obtaining a multiplication operation result of related data of the reciprocal of the exponential function value corresponding to the i^{th} element and the addition operation result; and
obtaining a reciprocal of the multiplication operation result, to obtain a Softmax function value corresponding to the i^{th} element.

13. The method according to claim 11, wherein
the exponential function value corresponding to an i^{th} element in the input data set is obtained by: obtaining the exponential function value corresponding to the i^{th} element in the input data set by using a first mapping relationship pre-stored in a lookup table module;
and/or
the reciprocal of the exponential function value corresponding to the i^{th} element is obtained by: obtaining the reciprocal of the exponential function value corresponding to the i^{th} element by using a second mapping relationship pre-stored in the lookup table module;
and/or
the reciprocal of the multiplication operation result, to obtain the Softmax function value corresponding to the i^{th} element is obtained by: obtaining the reciprocal corresponding to the multiplication operation result by using a third mapping relationship pre-stored in the lookup table module, to obtain the Softmax function value corresponding to the i^{th} element.

14. The method according to claim 12, wherein
the i^{th} element is data whose bit width is N1 bits, wherein the N1-bit data comprises an integer whose bit width is M1 bits and a decimal whose bit width is M2 bits;
the exponential function value corresponding to the i^{th} element is data whose bit width is N2 bits, wherein the N2-bit data comprises an integer whose bit width is M3 bits and a decimal whose bit width is M4 bits; and
the addition operation result is data whose bit width is N3 bits, wherein the N3-bit data comprises an integer whose bit width is M5 bits and a decimal whose bit width is M6 bits;
the reciprocal of the exponential function value corresponding to the i^{th} element is data whose bit width is N4 bits, wherein the N4-bit data comprises an integer whose bit width is M7 bits and a decimal whose bit width is M8 bits;
the multiplication operation result is data whose bit width is N5 bits, wherein the N5-bit data comprises an integer whose bit width is M9 bits and a decimal whose bit width is M10 bits; and
the reciprocal of the multiplication operation result is data whose bit width is N6 bits, wherein the N6-bit data comprises an integer whose bit width is M11 bits and a decimal whose bit width is M12 bits,
wherein values of M1 to M12 comprise at least one, or more, or all of the following: M1 is greater than M2, M3 is less than M4, M5 is greater than M6, M7 is greater than M8, M9 is greater than M10, M11 is less than M12, M9 is greater than or equal to M5, M9 is less than or equal to M7, M10 is greater than or equal to M6, and M10 is greater than or equal to M8.

15. The method according to claim 12, wherein
a bit width of the multiplication operation result is greater than a bit width of the reciprocal of the exponential function value corresponding to the i^{th} element and/or a bit width of the addition operation result; and/or
the bit width of the reciprocal of the exponential function value corresponding to the i^{th} element is greater than a bit width of the i^{th} element in the input data set; and/or
the bit width of reciprocal of the exponential function value corresponding to the i^{th} element is greater than a bit width of the exponential function value corresponding to the i^{th} element and a bit width of the specific function value; and/or
the bit width of the i^{th} element is equal to the bit width of the specific function value corresponding to the i^{th} element.

16. The method according to claim 11, wherein the bit widths of the data of the i^{th} element in the input data set, the exponential function value corresponding to the i^{th} element in the input data set, and the addition operation result range from 8 to 12.

17. The method according to claim 11, further comprising:
before the obtaining an exponential function value corresponding to an i^{th} element in an input data set, performing a subtraction operation on an i^{th} element in an initial data set and a maximum value in the initial data set, to obtain the i^{th} element in the input data set, and/or
after the obtaining a specific function value corresponding to the i^{th} element, converting the bit width of the specific function value.

18. The method according to claim 11, wherein the method is used for implementing a Softmax function layer of a neural network, wherein the neural network is configured to classify to-be-classified data; and
the to-be-classified data comprises at least one of voice data, text data, and image data.

19. An artificial intelligence accelerator, comprising:
a processor; and
a memory, storing executable code, wherein the executable code, when executed by the processor, causes the processor to perform the method according to claim 11.

20. An electronic device, comprising:
a processor, configured to send at least one of a first lookup table, a second lookup table, or a third lookup table to an artificial intelligence chip, wherein the first lookup table is used for implementing a first mapping relationship between an i^{th} element in an input data set and an exponential function value, the second lookup table is used for implementing a second mapping relationship between the i^{th} element in the input data set and a reciprocal of the exponential function value, the third lookup table is used for implementing a third mapping relationship between a multiplication operation result and a reciprocal of the multiplication operation result, the multiplication operation result being a result obtained by performing a multiplication operation on the reciprocal of the exponential function value corresponding to the i^{th} element and an addition operation result, and the addition operation result being an addition operation result of exponential function values corresponding to at least some elements in the input data set; and
an artificial intelligence chip, configured to perform the method according to claim 11 based on at least one of the first lookup table, the second lookup table, or the third lookup table.
